(19) United States
(12) Patent Application Publication
(10) Pub. No.: US 2025/0076715 A1
(43) Pub. Date: Mar. 6, 2025

(54) DISPLAY DEVICE

(71) Applicant: Innolux Corporation, Miao-Li County (TW)

(72) Inventors: Chien-Hung CHAN, Miao-Li County (TW); Jin-Yi TAN, Miao-Li County (TW); Cheng-Tso HSIAO, Miao-Li County (TW); Huang-Chi CHAO, Miao-Li County (TW); Ming-Feng HSIEH, Miao-Li County (TW); Ying-Jen CHEN, Miao-Li County (TW)

(21) Appl. No.: 18/953,207

(22) Filed: Nov. 20, 2024

Related U.S. Application Data
(63) Continuation of application No. 17/823,098, filed on Aug. 30, 2022.
Application No. 17/823,098 is a continuation of application No. 16/574,269, filed on Sep. 18, 2019, now abandoned.

(30) Foreign Application Priority Data
Oct. 16, 2018 (CN) 201811202395.8

(51) Int. Cl. G02F 1/1347; G02F 1/133; G02F 1/1333; G02F 1/1335

(52) U.S. Cl. CPC G02F 1/1347; G02F 1/13306; G02F 1/133308; G02F 1/133528

(57) ABSTRACT

A display device, characterized in that the display device includes a first panel, having a first side and a first light shielding layer at a periphery of the first panel, wherein the first light shielding layer has a first edge departing away from the first side; and a second panel, disposed on the first panel, and having a second side adjacent to the first side; wherein the second panel includes a second light shielding layer at a periphery of the second panel; and the second light shielding layer has a second edge departing away from the second side. Wherein a first width is measured from the first side to the first edge along a direction, a second width is measured from the second side to the second edge along the direction, the second width is greater than the first width, and the direction is vertical to the first side.

This is a Continuation application of U.S. application Ser. No. 17/823,098, filed at Aug. 30, 2022, which is a Continuation application of U.S. application Ser. No. 16/574,269, filed at Sep. 18, 2019, which claims the benefit of People's Republic of China application Serial No. 201811202395.8, filed Oct. 16, 2018, the subject matters of which are incorporated herein by reference.

### BACKGROUND OF THE DISCLOSURE

### Field of the Disclosure

The disclosure relates in general to a display device, and more particularly to a display device having a double-layered panel.

### Description of the Related Art

Conventional liquid crystal display devices may cause problems in brightness and color contrast reduction due to light leakage and the like, thereby affecting display quality. In order to solve this problem, a double-layered liquid crystal display device has been proposed. In the double-layered liquid crystal display, the light emitted from the backlight module can be modulated by a monochrome liquid crystal panel and a color liquid crystal panel stacked with each other before reaching the user's eyes, to make the black area of the images becoming deeper to get a higher contrast.

However, the conventional double-layered liquid crystal display device is formed by stacking two display panels. Since the four sides of the two display panels have a frame, the frames of the display panel that is adjacent to the backlight module can be seen by the user at oblique angles, which may cause reduction in brightness of the image around the display, and affect the user's visual quality.

Therefore, there is a need to provide an advanced display device to obviate the drawbacks and problems encountered from the prior art.

### SUMMARY

One aspect of the present disclosure is directed to a display device, wherein the display device includes a first panel and a second panel disposed on the first panel. The first panel has a first working area and a plurality of pixel areas disposed in the first working area; the second panel has a second working area and a plurality of pixel areas disposed in the second working area. The second working area overlaps with the first working area, and the second working area is smaller than the first working area.

In some embodiments of the present disclosure, the width of a first non-working area and a second non-working area can be estimated and adjusted by taking account the oblique viewing angles (predetermined visual angles), the refractive index of the second panel and the refractive index and the thicknesses of the optical films that is disposed between the first panel and the second panel. Such that, it can prevent the user from viewing the first non-working area of the first panel, when viewing the image in the oblique angle, so as to achieve the goal of providing the user with a better viewing experience.

### BRIEF DESCRIPTION OF THE DRAWINGS

The above and other aspects of the disclosure will become better understood with regard to the following detailed description of the embodiment(s). The following description is made with reference to the accompanying drawings:

FIG. 1A is a top view of a display device according to one embodiment of the present disclosure.

FIG. 1B is a cross-sectional view of the display device taken along the section line S1 depicted in FIG. 1A;

FIG. 1C is an enlarged cross-sectional view showing a partial structure of the display device of FIG. 1A;

FIG. 2 is an enlarged cross-sectional view showing a partial structure of a display device according to another embodiment of the present disclosure; and

FIG. 3 is an enlarged cross-sectional view showing a partial structure of a display device according to yet another embodiment of the present specification.

### DETAILED DESCRIPTION

The present disclosure provides a display device having a double-layer display panel to resolve the problem of brightness reduction around the display at oblique viewing angles, thereby better visual experience can be achieved. The above and other aspects of the disclosure will become better understood by the following detailed description of the embodiment(s). The following description is made with reference to the accompanying drawings.

Several embodiments of the present disclosure are disclosed below with reference to accompanying drawings. However, the structure and content disclosed in the embodiments are for exemplary and explanatory purposes only, and the scope of protection of the present disclosure is not limited to the embodiments. It should be noted that the present disclosure does not illustrate all possible embodiments, and anyone skilled in the technology field of the disclosure will be able to make suitable modifications or changes based on the specification disclosed below to meet actual needs without breaching the spirit of the disclosure. The present disclosure is applicable to other implementations not disclosed in the specification.

Further, the series terms used in the specification and the claims, such as “first”, “second” and the like, are used to modify the elements of the claim, which is not intended to indicate the number of identical requested element, or to represent the order of a request element and another request element, or to represent the order of manufacturing methods. These series terms are only used to make the request element having a certain name to clearly distinguish that of other identical elements.

In addition, the positions mentioned in the specification and claims, such as “above”, “upper”, “over”, “lower”, “beneath” or “under”, may either mean that the two elements are directly contact, or may mean that the two components are not in direct contact.

The embodiments and accompanying drawings of the present disclosure are provided for exemplary and explanatory purposes, not for limiting the scope of protection of the disclosure. Designations common to the accompanying drawings and embodiments are used to indicate identical or similar elements.

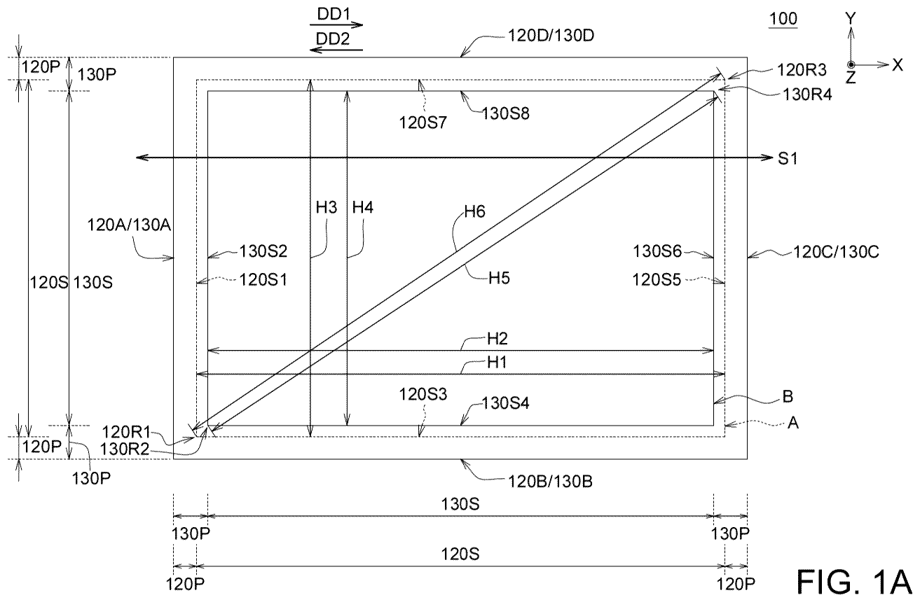

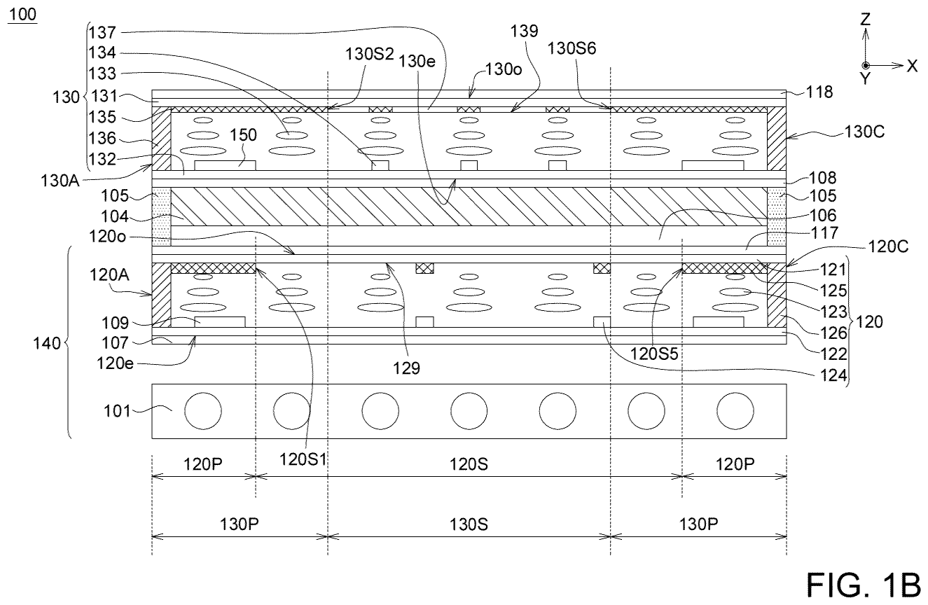

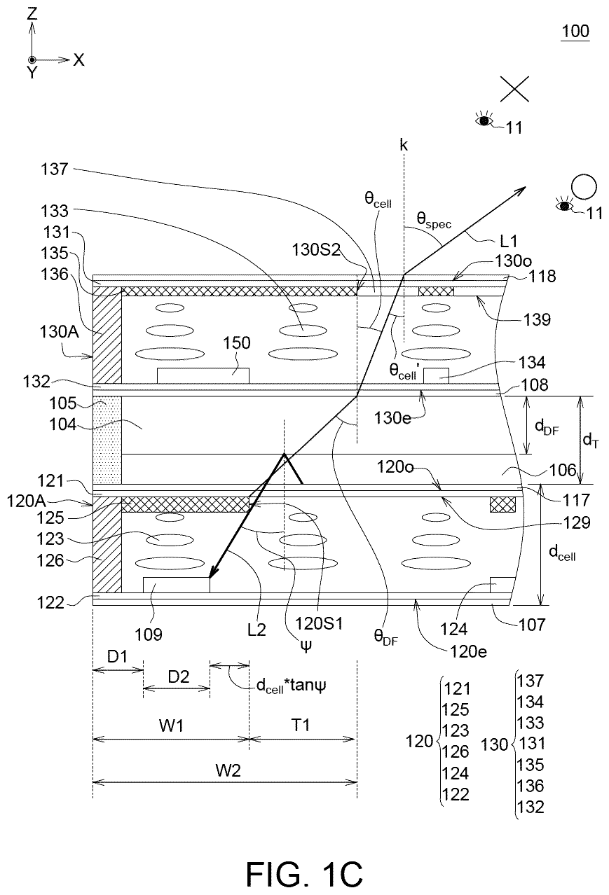

Referring to FIG. 1A to FIG. 1C, FIG. 1A is a top view of a display device 100 according to one embodiment of the present disclosure; FIG. 1B is a cross-sectional view of the display device 100 taken along the section line S1 depicted in FIG. 1A; and FIG. 1C is an enlarged cross-sectional view showing a partial structure of the display device 100 of FIG. 1A.

In some embodiments of the present disclosure, the display device 100 includes a display assembly 140 and a second panel 130. The display assembly 140 includes a first panel 120 and a backlight module 101. The backlight module 101 is disposed at one side of the first panel 120, and the second panel 130 is disposed above the first panel 120. The display device 100 may further include an optical film 104 disposed between the second panel 130 and the first panel 120. The first panel 120 is used to control the light source entering to the second panel 130, and the second panel 130 is used to control the displayed image, such that the second panel 130 is closer to the viewer than the first panel 120 (the user 11). The light source may be the self-illuminated light provided by the first panel 120 or the light provided by other sources and passing through the first panel 120.

In detail, the backlight module 101 is disposed on a light incident side 120e of the first panel 120; and the first panel 120 further includes a first polarizer 107 disposed on the light incident side 120e and a second polarizer 117 disposed on a light exiting side 1200 of the first panel 120. The light incident side 130e of the second panel 130 faces the light exiting side 1200 of the first panel 120. The light exiting side 1200 of the first panel 120 is the opposite side of the light incident side 120e. In addition, the second panel 130 further includes a third polarizing plate 108 disposed on the light incident side 130e and a fourth polarizing plate 118 disposed on a light exiting side 1300 of the second panel 130.

The first polarizer 107 has a first polarization axis perpendicular to a second polarization axis of the second polarizer 117; the third polarization axis of the third polarizer 108 is parallel to the second polarization axis of the second polarizer 117; The third polarization axis is perpendicular to a fourth polarization axis of the fourth polarizer 118. However, the arrangement of these polarizers and the polarization axis thereof are not limited thereto. The user 11 can view the image displayed by the display device 100 from the light exiting side 1300 of the second panel 130. In some embodiments, the first polarizer 107 can be optionally omitted, depending on design requirement.

The display device 100 can optionally include an optical film 104 interposed between the light exiting side 1200 of the first panel 120 and the light incident side 130e of the second panel 130. In some embodiments of the present disclosure, the first panel 120 is attached to the second panel 130 by a glue 105. The optical film 104 is attached to the light incident side 130e of the second panel 130. In one embodiment, an air gap 106 may be disposed between the optical film 104 and the light exiting side 1200 of the first panel 120. In some embodiments of the present disclosure, the thickness of the glue 105 in the Z axis direction may substantially range from 200 micrometers (μm) to 600 μm. For example, the glue 105 may be a foam glue made of polyurethane, but is not limited thereto. The optical film 104 can be a diffuser, a polarizer, or a combination of both, such as a polarizing brightness enhancing film.

In the present embodiment, the first panel 120 may include an upper substrate 121, a lower substrate 122, a liquid crystal layer 123, a plurality of thin film transistors 124, and a light shielding layer 125. The plurality of thin film transistors 124 are disposed on the lower substrate 122. The light shielding layer 125 is disposed on the upper substrate 121. The liquid crystal layer 123 is enclosed between the upper substrate 121 and the lower substrate 122 by a frame sealant 126. The thin film transistors 124 or the light shielding layer 125 may be selectively disposed on the upper substrate 121 or the lower substrate 122. However, the arrangement of the thin film transistors 124 and the light shielding layer 125 is not limited thereto. The first panel 120 may be a monochrome panel or a color panel, and is not limited herein. For example, if the first panel 120 is a color panel, the display color can be modulated by controlling the color of the light emitted by the first panel 120.

The first panel 120 includes a first working area 120S and a first non-working area 120P. The first working area 120S may be rectangular or other irregular shape, and is not limited thereto. A light shielding layer 125 disposed at the periphery of the first panel 120 is used to define a range of the first working area 120S and a range of the first non-working area 120P. The first working area 120S may be driven by an active matrix or a passive matrix. In the embodiment in which the first working area 120S is driven by the passive matrix, the first working area 120S can include a plurality of pixel regions 129. In the embodiment in which the first working area 120S is driven by the active matrix, the first working area 120S may include a plurality of pixel regions 129 and a plurality of thin film transistors 124. For example, in some embodiments of the present disclosure, each of the pixel regions 129 is an aperture region that allows light to pass there through. In other embodiments of the present disclosure, each of the pixel regions 129 may be a light passing region defined by the light shielding layer 125 (for example, a black matrix, a metal layer or the portions of a color filter layer on which different pigments are overlapped) in a liquid crystal display panel. Alternatively, each of the pixel regions 129 may be a light emitting region of an organic light-emitting layer in an organic light emitting diode or a light emitting region in an inorganic light-emitting diode. The first non-working area 120P is an area counted from the outer edge of the pixel regions 129 disposed at the outermost edge of the first working area 120S to the edge of the substrate (such as the upper substrate 121), wherein the first non-working area 120P may be covered by the light shielding layer 125. In some embodiments, a gate on panel (GOP) driving circuit 109 for driving the first panel 120 may be optionally disposed in the first non-working area 120P of the first panel 120.

In an embodiment in which the first working area 120S is rectangular, the edges of the light shielding layer 125 respectively departing away from the first side 120A, the second side 120B, the third side 120C, and the fourth side 120D of the first panel 120, are referred to as the first edge 120S1, the third edge 120S3, the fifth edge 120S5, and the seventh edge 120S7. Wherein, the areas adjacent to the first edge 120S1, the third edge 120S3, the fifth edge 120S5 and the seventh edge 120S7 can be referred to as the first working area 120S; and the area respectively extending from the first edge 120S1, the third edge 120S3, the fifth edge 120S5 and the seventh edge 120S7 of the first working area 120S to the first side 120A, the second side 120B, the third side 120C and the fourth side 120D of the first panel 120 can be referred to as the first non-working area 120P.

The light shielding layer 125 of the first non-working area 120P can be used to shield part of the light that is emitted outward through the light exiting side 1200 of the first panel 120 or to shield part of incident light coming from the outside. A pixel matrix having a plurality of pixel regions 129 can be formed in the first working area 120S by using the plurality of pixel regions 129 and the plurality of thin film transistors 124 disposed in the first working area 120S according to the resolution requirement of the first panel 120. In some embodiments of the present disclosure, the light shielding layer 125 may be made of a black matrix or other light blocking material, such as a metal.

It should be noted that the display assembly 140 formed by the first panel 120 and the backlight module 101 described above may be replaced by other display assemblies. For example, in other embodiments of the present disclosure, the display assembly 140 may be an inorganic light emitting diode (LED) display panel, a mini LED display panel, a micro LED display panel, a quantum dot (QD) display panel or an organic light-emitting diode (OLED) display panel that does not require a backlight source or an electronic ink (E-Ink) requiring a backlight source. In one embodiment, the size of the LED die in the LED display panel is about 300 μm to 10 millimeters (mm), the size of the mini LED die in the mini LED display panel is about 100 μm to 300 μm, and the size of the micro LED die in the micro LED display panel is about 1 μm to 100 μm. However, the die size of these display panels may not be limited thereto.

The second panel 130 can be a color panel, including an upper substrate 131, a lower substrate 132, a liquid crystal layer 133, a plurality of thin film transistors 134, a light shielding layer 135, and a color filter 137. The color filter 137 can be disposed corresponding to a plurality of pixel regions 139. The plurality of thin film transistors 134 are disposed on the lower substrate 132. The light shielding layer 135 is disposed on the upper substrate 131. The liquid crystal layer 133 is enclosed between the upper substrate 131 and the lower substrate 132 by a frame sealant 136. The thin film transistors 134, the light shielding layer 135 or the color filter 137 may be selectively disposed on the upper substrate 131 or the lower substrate 132. However, the arrangement of these components may not be limited thereto. For example, the thin film transistors 134, the light shielding layer 135, and the color filter layer 137 may all be disposed on the same substrate, wherein the thin film transistors 134, the light shielding layer 135, and the color filter layer 137 may all be disposed on the same substrate, wherein the substrate can be the upper substrate or the lower substrate, and the selection of the substrate may depend upon the design requirement of the display device 100.

The upper substrate 121, the lower substrate 122, the upper substrate 131, and the lower substrate 132 may be a rigid substrate or a flexible substrate. The materials of the upper substrate 121, the lower substrate 122, the upper substrate 131, and the lower substrate 132 may include (but not limited to) glass, polyimide (PI), polyethylene terephthalate (PET), or any other material suitable for forming a substrate.

The second panel 130 includes a second working area 130S and a second non-working area 130P. The second working area 130S may be rectangular or other irregular shape, and is not limited thereto. A light shielding layer 135 disposed at the periphery of the second panel 130 is used to define the second working area 130S and the second non-working area 130P. The second working area 130S includes a plurality of pixel regions 139 and a plurality of thin film transistors 134. For example, in some embodiments of the present disclosure, each of the pixel regions 139 is an aperture region that allows light to pass there through. In other embodiments of the present disclosure, each of the pixel regions 139 may be a light passing region defined by the light shielding layer 135 (for example, a black matrix, a metal layer or the portions of a color filter layer on which different pigments are overlapped) in a liquid crystal display panel. The second non-working area 130P is an area counted from the outer edge of the pixel regions 139 disposed at the outermost edge of the second working area 130S to the edge of the substrate (such as the upper substrate 131), wherein the second non-working area 130P may be covered by the light shielding layer 135. In some embodiments, a gate on panel (GOP) driving circuit 150 for driving the second panel 130 may be optionally disposed in the second non-working area 130P of the second panel 130. The gate on panel (GOP) driving circuit 150 for driving the second panel 130 may overlap with the gate on panel (GOP) driving circuit 109 for driving the first panel 120.

In an embodiment in which the second working area 130S is rectangular, the edges of the light shielding layer 135 respectively departing away from the fifth side 130A, the sixth side 130B, the seventh side 130C, and the eighth side 130D of the second panel 130, are referred to as the second edge 130S2, the fourth edge 130S4, the sixth edge 130S6, and the eighth edge 130S8. Wherein, the areas adjacent to the second edge 130S2, the fourth edge 130S4, the sixth edge 130S6, and the eighth edge 130S8 is the second working area 130S; and the area from the second edge 130S2, the fourth edge 130S4, the sixth edge 130S6, and the eighth edge 130S8 of the second working area 130S respectively extending to the fifth side 130A, the sixth side 130B, the seventh side 130C, and the eighth side 130D of the second panel 130 can be referred to as the second non-working area 130P.

The light shielding layer 135 of the second non-working area 130P can be used to shield part of the light that is emitted outward through the light exiting side 1300 of the second panel 130 or to shield part of incident light coming from the outside. A pixel matrix having a plurality of pixel regions 139 can be formed in the second working area 130S by using the plurality of pixel regions 139 and the plurality of thin film transistors 134 disposed in the second working area 130S according to the resolution requirement of the second panel 130. In some embodiments of the present disclosure, the light shielding layer 135 may be made of a black matrix or other light blocking material, such as a metal. The resolution of the second panel 130 may be greater than (but not limited to) that of the first panel 120.

Referring to FIG. 1A, the first panel 120 has a first side 120A, a second side 120B, a third side 120C, and a fourth side 120D; wherein the first side 120A and the third side 120C are opposite to each other; and the second side 120B and the fourth side 120D are opposite to each other. The second panel 130 has a fifth side 130A, a sixth side 130B, a seventh side 130C, and an eighth side 130D; wherein the fifth side 130A and the seventh side 130C are opposite each other; and the sixth side 130B and the eighth side 130D are opposite to each other. In some embodiments of the present specification, the first side 120A of the first panel 120 aligns to the fifth side 130A of the second panel 130, and the third side 120C of the first panel 120 aligns to the seventh side 130C of the second panel 130. However, the arrangement of these sides is just exemplar but not limited thereto.

The first edge 120S1 of the first working area 120S and the second edge 130S2 of the second working area 130S are both adjacent to the first side 120A of the first panel 120; the third edge 120S3 of the first working area 120S and the fourth edge 130S4 of the second working area 130S are both adjacent to the second side 120B of the first panel 120; the fifth edge 120S5 of the first working area 120S and the sixth edge 130S6 of the second working area 130S are both adjacent to the third side 120C of the first panel 120; the seventh edge 120S7 of the first working area 120S and the eighth edge 130S8 of the second working area 130S are both adjacent to the fourth side 120D of the first panel 120.

In one embodiment of the present disclosure, the first working area 120S of the first panel 120 overlaps with the second working area 130S of the second panel 130. The area of the first working area 120S of the first panel 120 is referred to as the first area A; the area of the second working area 130S of the second panel 130 is referred to as the second area B, and the second area B overlaps with the first area A; the area A is larger than the second area B; and the second area B is disposed within the first area A, when viewed at a top view.

Referring to FIG. 1A again, to take the rectangle first working area 120S as an example, the area surrounded by the first edge 120S1, the third edge 120S3, the fifth edge 120S5, and the seventh edge 120S7 of the first panel 120 (the area surrounded by a broken line), is referred to as the first area A. The second working area 130S, the area surrounded by the second edge 130S2, the fourth edge 130S4, the sixth edge 130S6, and the eighth edge 130S8 of the second panel 130 (the area surrounded by the solid line), is referred to as the second area B. Wherein the second area B overlaps with the first area A; and the second area B is disposed within the first area A, when views at a top view. In the present embodiment, the first area A is larger than the second area B.

In another embodiment, along a direction X, the maximum width of the first working area 120S of the first panel 120 is greater than the maximum width of the second working area 130S of the second panel 130. In one embodiment, along a direction Y, the maximum width of the first working area 120S of the first panel 120 is greater than the maximum width of the second working area 130S of the second panel 130. In yet another embodiment, along another direction different from the direction X and the direction Y, the maximum width of the first working area 120S of the first panel 120 is greater than the maximum width of the second working area 130S of the second panel 130. The shape of the first working area 120S and the second working area 130S may be (but not limited to) rectangular, circular or irregular.

For example, referring to FIG. 1A again, in the present embodiment, the distance H1 between the first edge 120S1 and the fifth edge 120S5 is greater than the distance H2 between the second edge 130S2 and the sixth edge 130S6; or The distance H3 between the third edge 120S3 and the seventh edge 120S7 is greater than the distance H4 between the fourth edge 130S4 and the eighth edge 130S8.

In still another embodiment, the first working area 120S and the second working area 130S respectively have a first lead angle 120R1 and a second lead angle 130R2 both adjacent to an intersection of the first side 120A and the second side 120B as well as a third lead angle 120R3 and a fourth lead angle 130R4 both adjacent to an intersection of the third side 120C and the fourth side 120D. Wherein, the distance H6 between the first lead angle 120R1 and the third lead angle 120R3 is greater than the distance H5 between the second lead angle 130R2 and the fourth lead angle 130R4. However, the size or shape of the first working area 120S and the second working area 130S are not limited thereto.

Referring to FIG. 1C, in the present embodiment, the first non-working area 120P and the second non-working area 130P respectively have a first width W1 and a second width W2, wherein the first width W1 is the distance measured from the first side 120A of the first panel 120, along the direction X, to the first edge 120S1; the second width W2 is the distance measured from the fifth side 130A of the second panel 130, along the direction X, to the second edge 130S2; and the second width W2 is greater than the first width W1. Within a predetermined viewing angle θ_{spec} (as shown in FIG. 1C), when the user 11 views the display device 100 obliquely at an angle between the normal line K perpendicular to the second panel 130 and the predetermined viewing angle θ_{spec}, the non-working area 120P of the first panel 120 is not seen. The difference T1 between the second width W2 and the first width W1 can be estimated by taking account the size of the predetermined viewing angle θ_{spec}, the refractive index η_{cell} of the second panel, the refractive index η_{DF} of the optical film 104, and the thickness d_{DF} of the optical film 104. Wherein, the predetermined viewing angle θ_{spec} may range from 45° to 60°.

As shown in FIG. 1C, the refractive path of the emitting light L1 coming from the display device 100 at the predetermined viewing angle θ_{spec} is illustrated. In order to prevent the user 11 from viewing the first non-working area 120P of the first panel 120 within the predetermined viewing angle θ_{spec}, some conditions should be satisfied. In one embodiment of the present disclosure, assuming that the air gap between the optical film 104 and the light exiting side 1200 of the first panel 120 is very small (or absent), wherein the refractive index is not considered, the light emitting L1 coming from the first edge 120S1 of the first panel 120 may pass through the optical film 104 to reach the second edge 130S2 of the second panel 130, and then may be incident into the second panel 130 from the light incident side 130e of the second panel 130 at an incident angle θ_{DF}. After being refracted by the second panel 130 at an angle of refraction θ_{cell}, the refracted emitting light L1 is outwardly emitted into the outside air from the light exiting side 1300 of the second panel 130 at an incident angle θ_{cell′}, whereby the refraction angle of the light emitting L1 that is incident into the outside air can be limited within the range of the predetermined viewing angle θ_{spec}.

According to Snell's Law, the relationship between the incident angle θ_{DF} and the refraction angle θcell can be derived as follows:

$$sin {θ}_{DF} \times {η}_{DF} = sin {θ}_{cell} \times {η}_{cell} \qquad ( 1 )$$

The relationship between the incident angle θ_{cell′} (according to the angle bisector theorem, the incident angle θ_{cell′} is equal to the refraction angle θ_{cell}) by which the emitting light L1 is emitted into the outside air from the second panel 130 and the predetermined viewing angle θ_{spec} is:

$$sin {θ}_{spec} \times {η}_{spec} = sin {θ}_{{cell}^{′}} \times {η}_{cell} \qquad ( 2 )$$

Wherein η_{DF} is the refractive index of the optical film 104, η_{cell} is the refractive index of the second panel 130, and η_{spec} is equal to 1.

Base on the above relationships (1) and (2), a relation (3) can be derived by the following operation:

$${θ}_{DF} = {sin}^{- 1} ( \frac{{η}_{spec} \times Sin {θ}_{spec}}{{η}_{DF}} ) \qquad ( 3 )$$

Then, bring the relationship (3) into the trigonometric functions (4) related to the difference T1 between the second width W2 and the first width W1 and the refraction angle θ_{DF}:

$$W 2 - W 1 = {d}_{DF} \times tan {θ}_{DF} = {d}_{DF} \times tan ( {sin}^{- 1} ( \frac{Sin {θ}_{spec}}{{η}_{DF}} ) ) \qquad ( 4 )$$

Wherein d_{DF} is the thickness of the optical film 104. In one embodiment of the present disclosure, the optical film 104 may be a diffusion sheet having a thickness of about 50 μm, plus a haze gel (not shown) having a thickness ranging substantially from 15 μm to 50 μm. Such that the d_{DF} may substantially range between 65 μm to 100 μm. Since the refractive index of the haze adhesive (not shown) is close to the refractive index of the optical film 104, the refractive index nor of the optical film 104 described in this embodiment may be obtained by summing up these two refractive index values and getting the average thereof, in some embodiments of the present specification, the refractive index nor may range from 1.4 to 1.6. In the present embodiment, the difference T1 between the second width W2 and the first width W1 can be the distance between the first edge 120S1 of the first working area 120S of the first panel 120 and the second edge 130S2 of second working area 130S of the second panel 130.

In some embodiments of the present specification, if the thickness and the refraction effect of the air gap 106 are considered, the total thickness dr of both the optical film 104 and the air gap 106 can be further measured, and integrated refractive index η_{T} of the optical film 104 and the air gap 106 (refractive index is 1) can be obtained according to the Snell's law. When the d_{T} and the η_{T} take the place of the thickness d_{DF} and the refractive index nor in the above relationships (1), (2), (3), and (4), a new relationship (5) can be obtained:

$$W 2 - W 1 = {d}_{T} \times tan {θ}_{DF} = {d}_{T} \times tan ( {sin}^{- 1} ( \frac{Sin {θ}_{spec}}{η T} ) ) \qquad ( 5 )$$

In addition, in one embodiment, a gate on panel (GOP) driving circuit 109 for driving the first panel 120 may be configured on the first non-working area 120P of the first panel 120. The gate on panel (GOP) driving circuit 109 includes at least one thin film transistor (not shown). It is noted that the size of the at least one thin film transistor of the gate on panel (GOP) driving circuit 109 may be larger than the size of the thin film transistors 124 disposed in the first working region 120S.

In order to prevent the light L2 reflected by the optical film 104 (passing through the air gap 106) from entering the channel of the thin film transistors in the gate on panel (GOP) driving circuit 109 adjacent to the first working region 120S, which may cause light induced current leakage and adversely affect the normal operation of the display device 100; the first width W1 of the first non-working area 120P of the first panel 120 should satisfy the condition of the following relationship (6):

$$W 1 \geq D 1 + D 2 + ( {d}_{cell} \times tan ∅ ) \qquad ( 6 )$$

Wherein D1 is the distance from the first side 120A of the first panel 120 to the gate on panel (GOP) driving circuit 109 adjacent to the first side 120A; D2 is the (channel) width of the gate on panel (GOP) driving circuit 109; d_{cell} is the thickness of the first panel 120. Ø refers to the refraction angle of the light L2 reflected by the optical film 104 after being incident onto the first panel 120. According to the general optical principle, the refraction angle Ø is generally less than 45°. Where W1, D1, D2, and d_{cell} have the same unit.

In summary, the manufacturer of the display device 100 can estimate and then adjust the first width W1 of the first non-working area 120P of the first panel 120 and the second width W2 of the second non-working area 130P of the second panel 130 by considering the predetermined viewing angle θ_{spec}, the refractive index η_{cell} of the second panel 130, the refractive index nor of the optical film 104, and the thickness d_{DF} of the optical film 104, for the purpose of preventing the user 11 from viewing the first non-working area 120P of the first panel 120, that may adversely affect the image quality, within the predetermined viewing angle θ_{spec}, so as to provide better viewing experience for the user 11.

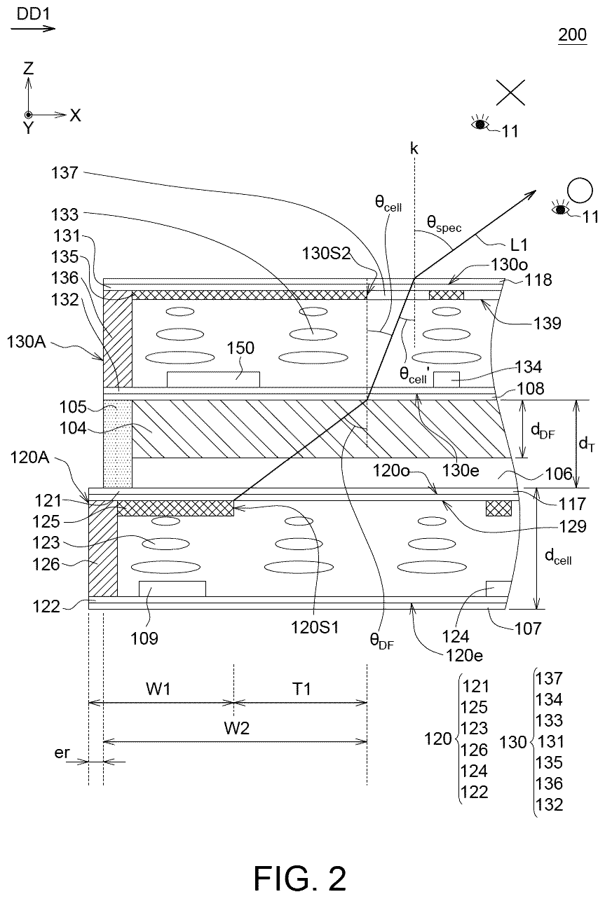

FIG. 2 is an enlarged cross-sectional view showing a partial structure of a display device 200 according to another embodiment of the present disclosure. The structure of the display device 200 is similar to that of the display device 100 illustrated in FIG. 1C, with the difference that the sides of the second panel 130 (eg, the fifth side 130A) does not align with the sides of the first panel 120 (eg, the first side 120A), and there has a distance er between these two sides. The distance er can facilitate the assembly of the second panel 130 and the first panel 120 of different sizes to increase the product design flexibility of the display device 200. For example, the fifth side 130A of the second panel 130 is not aligned with the first side 120A of the first panel 120, and the fifth side 130A shifts, along the first direction DD1, with respect to the first side 120A for a distance er, wherein the difference T1 between the second width W2 and the first width W1 may satisfy the condition in accordance with the relationship (7):

$$W 2 - W 1 = {d}_{D F} \times tan ( {sin}^{- 1} ( \frac{Sin {θ}_{s p e c}}{{η}_{D F}} ) ) + er \qquad ( 7 )$$

In some embodiments of the present disclosure, the distance er may range from 100 μm to 200 μm, and the d_{DF} has the same unit as er. In the present embodiment, the distance er, along the first direction DD1, in the relationship (7) can be a negative value.

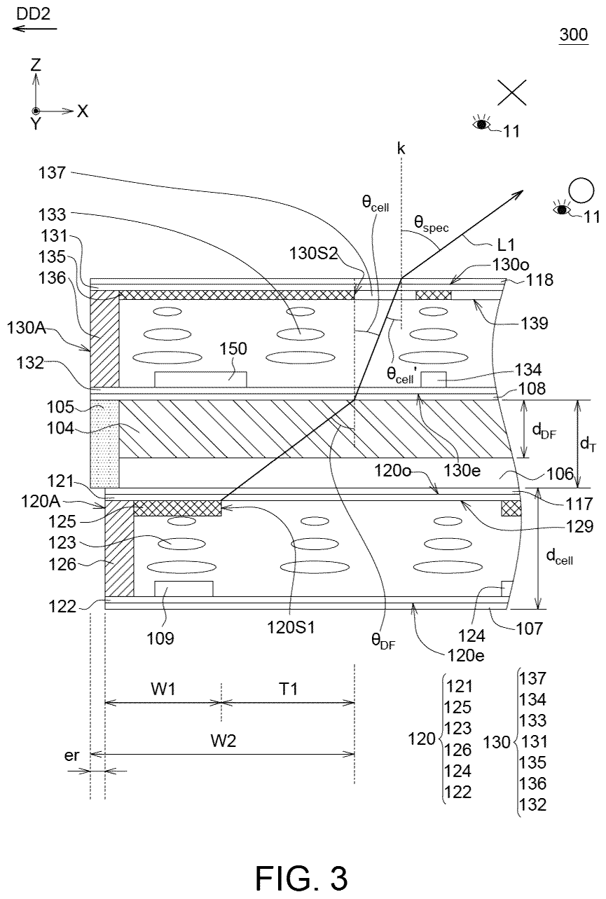

FIG. 3 is an enlarged cross-sectional view showing a partial structure of a display device 300 according to yet another embodiment of the present specification. The structure of the display device 300 is substantially similar to the display device 100 illustrated in FIG. 1C except that the fifth side 130A of the second panel 130 is not aligned with the first side 120A of the first panel 120, and the fifth side 130A shifts, along the second direction DD2, relative to the first side 120A for a distance er, wherein the difference T1 between the second width W2 and the first width W1 may satisfy the condition in accordance with the relationship (8):

$$W 2 - W 1 = {d}_{D F} \times tan ( {sin}^{- 1} ( \frac{Sin {θ}_{s p e c}}{{η}_{D F}} ) ) + er \qquad ( 8 )$$

In some embodiments of the present disclosure, the distance er may range from 100 μm to 200 μm, and the d_{DF} has the same unit as er. In the present embodiment, the distance er, along the first direction DD2, in the relationship (8) can be a positive value.

It should be noted that although the first panel 120 and the second panel 130 of the display device 100 are all shaped as rectangular, the shapes of the first panel 120 and the second panel 130 of the display device 100 may not limited to this regard. The shapes of the first panel 120 and the second panel 130 may be triangular, prismatic, trapezoidal, wedge-shaped, polygonal or irregular shapes with arc edges; and the shapes of the first panel 120 and the second panel 130 may be the same or different from each other. As long as the second working area 130S of the second panel 130 (the second area B) is smaller than the first working area 120S of the first panel 120 (the first area A), and the second working area 130S of the second panel 130 overlaps with the first working area 120S of the first panel 120, the size of these two is not strictly limited. The size of the first panel 120 and the second panel 130 can be the same or different from each other.

In some other embodiments, by considering the size of the predetermined viewing angle, the refractive index of the second panel, the refractive index and thickness of the optical film between the first panel and the second panel, the width of the first non-working area and the second non-working area can be estimated and adjusted to prevent the user from being affected by the first non-working area of the first panel when viewing the image from an oblique angle, so as to provide the user with better viewing quality.

While the disclosure has been described by way of example and in terms of the embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display device, characterized in that the display device comprises:
a first panel, comprising:
a first side;
a first peripheral non-working area;
a first working area; and
a first light shielding element having a second side and covering the first peripheral non-working area, wherein the second side of the first light shielding element is connected between the first peripheral non-working area and the first working area, and a distance between the second side and the first side defines a first width of the first peripheral non-working area in a first direction; and
a second panel disposed on the first panel, comprising:
a third side adjacent to the first side and not align with the first side;
a second peripheral non-working area;
a second working area; and
a second light shielding element having a fourth side and covering the second peripheral non-working area, wherein the fourth side of the second light shielding element is connected between the second peripheral non-working area and the second working area, and a distance between the fourth side and the third side defines a second width of the second peripheral non-working area in the first direction;
wherein the second width is greater than the first width.

2. The display device according to claim 1, wherein the second panel further comprises an upper substrate, a lower substrate and a liquid crystal layer enclosed between the upper substrate and the lower substrate, and the second light shielding element is disposed on the upper substrate.

3. The display device according to claim 2, wherein the second panel further comprises a color filter disposed on the upper substrate.

4. The display device according to claim 1, further comprising a backlight module, wherein the first panel is disposed between the second panel and the backlight module.

5. The display device according to claim 1, wherein the first light shielding element and the second light shielding element are made of black matrixes.

6. The display device according to claim 1, wherein the first panel comprises a first pixel region defined by the first light shielding element and a third light shielding element, the second panel comprises a second pixel region defined by the second light shielding element and a fourth light shielding element, the first pixel region has a third width, the second pixel region has a fourth width, and the fourth width is less than the third width.

7. The display device according to claim 6, wherein a width of the third light shielding element is less than a width of the fourth light shielding element.
